(19) United States
(12) Patent Application Publication
(10) Pub. No.: US 2024/0232969 A1
(43) Pub. Date: Jul. 11, 2024

(54) NETWORKED SUPPLY CHAIN MARKETPLACE FOR THE CONSTRUCTION INDUSTRY

(71) Applicant: Matthew H. Williams, South Abington, PA (US)

(72) Inventor: Matthew H. Williams, South Abington, PA (US)

(21) Appl. No.: 18/392,499

(22) Filed: Dec. 21, 2023

Related U.S. Application Data
(60) Provisional application No. 63/477,894, filed on Dec. 30, 2022.

(51) Int. Cl. G06Q 30/0601; G06Q 10/083; G06Q 50/08

(52) U.S. Cl. CPC G06Q 30/0619; G06Q 10/083; G06Q 50/08

(57) ABSTRACT

A novel networked supply chain marketplace system is described for managing construction resources employing a Server and a plurality of remote Mobile Computing Devices (“MCDs”). The system employs an advertising (Posting) function, private jobsite communication (Networking) function, and calculation tools. Construction entities (“Entities”) are ‘onboarded’ by providing information about their company, what construction resources they ‘Have’ to offer, and what construction resources that they ‘Need’. A graphical map interface selectively shows the locations of Entities, their ‘Haves’ and ‘Needs’, the jobsite location with additional information about each, including search analytics. Entities can Post their ‘Needs’. Other entities notify the Posting Entity of their ‘Haves’ that match the ‘Needs’ Posted. Optionally, a General Contractor in charge of completing the jobsite invites Entities into a private communication network for a jobsite to manage these entities. Unique tools are used to estimate the volume of various shapes to fill.

### CROSS-REFERENCE TO RELATED APPLICATION

This application claims the benefit of U.S. Provisional Patent application “NETWORKED SUPPLY CHAIN MARKETPLACE FOR THE CONSTRUCTION INDUSTRY”, application Ser. No. 63/477,894, filed Dec. 30, 2022 and incorporated into this application as if it were included in its entirety, except for any provisions which conflict with the current application.

### STATEMENT REGARDING FEDERALLY SPONSORED RESEARCH

Not Applicable.

### BACKGROUND

### 1. Field of Invention

The present invention relates to a mobile supply chain network for efficiently linking construction supplies, construction materials, equipment, and contractors to those in need of such resources. In particular, the present invention relates to a mobile supply chain network for efficiently linking supplies, construction materials, equipment, and contractors to those in need of such resources that minimize waste.

### 2. Description of Related Art

### Current System is Inefficient

A contractor building on a construction site paid to have about 100 triaxle loads of fill hauled to a remote dump site. He later found out, the day after they had hauled away the fill, that the neighboring property would have accepted it all. With a little more information, this contractor would have saved the time, effort, and cost of hauling these loads. Also, the neighboring property would have received its needed fill quickly and at a lower cost.

This situation is currently happening at many construction jobsites across the country, not only for fill but also for building materials, supplies, and equipment.

Each truckload burned a significant amount of diesel fuel, adding to climate change. With the high cost of diesel fuel now, this was a waste of funds. Also, the shortage of trucking capacity tied up trucks that could have been put to better use.

Currently, there is a need for a system in the construction industry that would more quickly and efficiently match those needing materials, supplies, and manpower with those nearby having these resources.

### Supply Chain Delays

It is important in the construction industry to provide timely access to manpower, equipment, supplies, and other construction resources.

Being able to find exactly what you need to complete the job, has become more difficult due to supply chain shortages. Before COVID-19, accessing wood, soil, and other aggregates was easier. A contractor would visit their local big box retail chain and order the necessary materials. The construction industry took an extremely hard hit during the pandemic and the subsequent labor shortages that followed, causing major disruption and delays in the supply chain.

Now, builders are increasingly looking for more efficient ways to obtain the resources that they need. It would be beneficial to have a system that efficiently links those with construction resources with those needing construction resources.

### Difficult to Find Local Supplies and Material

When constructing a structure, there are many tasks to be performed. Take, for example, a company such as a national drug store chain headquartered in Rhode Island that would like to build another store in northeastern Pennsylvania. The contractor has little knowledge of resources near northeastern Pennsylvania.

The entity having final responsibility for completing the project will be referred to as the General Contractor (GC). Therefore, the GC would have to care of real estate matters, such as finding and purchasing or leasing land to build the structure.

The GC would have to obtain equipment to clear the land or sign up a contractor to clear the land.

It would be beneficial to have a system that would identify the locations of various local construction services and suppliers.

The GC will then need equipment to level the land and fill in low sections. Even if fill is found from a supplier, it must be trucked to the jobsite. Also, all building materials must be acquired and trucked to the construction site.

Since the materials and equipment are bulky and heavy, it can be costly to transport these large distances. It would be beneficial to have a system that displays available local services and suppliers.

It would also be beneficial to have a system that displays local services and suppliers that are needed.

### Need for Local Contractors

Contractors are also required to perform environmental studies, erosion control studies, acquiring permits, excavating, drilling, blasting rocks, providing cranes, rigging, framing, welding, installing wiring, carpentry, stone masonry, plumbing, painting, roofing, floor installation, etc. These contractors are typically required to be licensed in the area where they work. Many of these Contractors charge a travel fee. Therefore, it is beneficial to acquire materials and equipment and use local contractors near the construction site.

Each contractor (Entity) may have or need any of the resources listed above. In reality, most entities both have and need resources.

It would be beneficial to have a system that displays available local contractors.

It would be beneficial to have a system that displays needed local contractors.

It would also be beneficial to have a system that displays contractors in a local area with construction materials, supplies, or equipment.

It would also be beneficial to have a system that displays contractors in a local area that need construction materials, supplies, or equipment.

### Lack of Addresses

Many jobsites do not have a formal street address early in construction. The address is assigned later. Therefore, the delivery of materials and supplies is problematic.

It would be beneficial to have a system that can define locations without the need for a formal street address.

### Communication Problems

Once the contractor finds the entities who will be working on the job, there is the problem of having them all effectively communicate with each other, as well as with the GC. The GC typically spends a lot of time notifying and directing various entities during construction. Several entities may provide, for example, paving equipment, all located at different locations that use different types of communications.

It would be beneficial to have a communication system that allows communication between specified entities invited to work on a jobsite.

Also, we would like to minimize the chances that one of the contractors incorrectly begins communicating with an entity working on a different jobsite or project, causing confusion. It is beneficial to have a system that identifies entities invited to work on a jobsite and allows them to communicate with each other.

### Human Error

Contractors currently manually estimate the amount of construction materials required for each task. For example, if there is a rectangular depression that the contractor needs to fill, the contractor manually calculates the volume to be the length times the width, times the depth, and converts this into cubic yards as an estimate. There are different formulas for different geometric shapes. If the wrong formula is used, the estimate will be incorrect. This may result in the contractor buying much more material than is required, or buying less than is required, causing the task to be delayed.

It would be beneficial if a simple calculator would reduce human error by automatically estimating the volumes of materials required for common fill shapes.

### BRIEF SUMMARY OF THE INVENTION

This invention is a new and novel mobile supply chain network for the construction industry.

Some Entities have construction resources, such as materials, supplies, and equipment that they would like to supply. Each specific resource that can be offered is referred to as a ‘Have’. For example, a cement company has a job that only requires ⅓ of a truckload. The Entity can make a post indicating that it has ⅔ of a truckload of concrete that it can deliver on a specified day.

On the other hand, some entities may need a piece of construction equipment, such as a concrete leveler. This would be a ‘Need’ for the concrete leveler.

The current system allows each Entity to post their ‘Haves’ or ‘Needs’ to the entities signed up with the current system.

The current system allows construction companies to sign up for an account and onboard their information. Only construction companies and those working in the construction industry may open an account. Others are restricted, resulting in pro-to-pro connections only. Restricting membership to construction entities filters out advertisers and others, which would result in many unwanted responses. The current system filters out the noise of unrelated businesses and services, as found in other internet searches.

Example. An internet search of “clean fill Scranton” will produce thousands of results varying in merit and substance. Many results will be completely unrelated to the desired information requested in the search. A search on the current invention for “clean fill Scranton” will produce only listings closely related to obtaining or getting rid of clean fill.

The current system integrates a user-created ‘Jobsite’ with ‘Haves’ and ‘Needs’. A Jobsite can associate specific ‘Haves’ and ‘Needs’ linked to real-time data to determine which ‘Needs’ and ‘Haves’ are active or have been fulfilled. This interactive updating helps the Entities understand the tasks completed or left to complete at a specific Jobsite within the app. This real-time updating allows for more accurate estimating of job status, potential completion, etc.

One ‘Have’ does not necessarily fulfill one ‘Need’. For example, if an Entity needs 5000 pounds of gravel, it can be fulfilled by several entities, each providing a portion of the gravel until they reach 5000 pounds. The current invention allows entities to sell off small excesses from another Jobsite that would otherwise be wasted.

The current system incorporates a novel Calculator function. It allows the user to select shapes and add dimensions. It then calculates the cubic yards of fill required to fill the shape.

The calculator also estimates square footage and required amounts of concrete or asphalt to complete a job.

The calculator also converts the answers to other measurement units such as yardage, footage, and acreage.

The current invention may be embodied as a networked supply chain marketplace having a Providing Remote Computing Device (RCD) associated with a construction entity that communicates that a Providing Entity has excess construction resources available at a location that it would like to provide to another construction entity. It also includes a plurality of Requesting RCDs each associated with a Requesting Construction Entity requiring construction resources, each coupled to the Providing RCD capable of receiving the communication from the Providing RCD defining the excess construction resources, the amount and their location, wherein the Requesting RCDs are capable of asking questions to, receiving answers from, negotiating with and accepting the excess construction resource from the Providing RCD. After one of the Requesting RCDs accepts the excess construction resources, the Providing RCD indicates that the excess construction resources are no longer available.

The current invention may be embodied as a networked supply chain marketplace system for the construction industry having a plurality of Mobile Computing Devices (“MCDs”), each associated with a construction Entity, whereas one of the Entities is a General Contractor (GC) in charge of completing construction on a jobsite.

The MCD receives and transmits the GC's determination of which Entities will be on a team working on the jobsite, wherein each MCD is capable of displaying an interactive map showing the locations of jobsites and other construction entities that are offering construction resources, and construction entities that are requesting construction resources, and each MCD has an internal Memory capable of storing information of its associated Entity's jobsites, excess construction resources that it has for the jobsite, and the construction resources it needs to complete work on a jobsite.

Each MCD also is capable of interacting with its associated Entity to create and send posts offering excess construction resources that it has that it would like to offer to other Entities. Each MCD also is capable of interacting with its associated Entity to create and send posts requesting construction resources that it needs from other Entities.

The system also includes a Server coupled to the plurality of MCDs, is adapted to receive indications from the MCD associated with the GC on which Entities are authorized to work on the jobsite, and will be part of the private network; set up connections to allow team members to freely communicate with each other in the private network; receive posts from the MCDs and determine which other MCDs should receive the posts, and provide the Posts to those remote Entities that should receive them; and connect MCDs to allow them to communicate with each other, upon request.

The current invention may also be embodied as a networked construction resource marketplace having a first plurality of remote computing device (RCD) each associated with a Requesting Entity requiring construction resources, the RCD capable of posting a description of the construction resources needed with a location where the construction resource is needed, a second plurality of remote computing device (RCD) each associated with a Providing Entity having excess construction resources that it intends to provide with a location of where the excess construction resource is located; and a server coupled to and communicating with the RCDs of the Requesting Entities and the RCDs of the Providing Entities. The Server can provide visual representations of locations and descriptions of the excess construction materials, and locations and descriptions of the construction materials needed. The Server is also capable of calculating routes and cost of delivery between various locations of excess construction materials and locations where these materials are required. The Server is capable of connecting RCDs of Requesting Entities with RCDs of Providing Entities to communicate, communicating descriptions of the construction resources to the Providing Entities and Requesting Entities. The Server is also capable of coupling RCDs to allow Requesting Entities to communicate with Providing Entities and complete deals. The Server is also capable of calculating routes between specific locations of the excess construction resource and location where the resource is required and calculating the costs for delivery. The Server is also capable of tracking the locations of the excess construction materials as they are delivered and providing visual representations of progress of delivery of the excess construction materials.

### BRIEF DESCRIPTION OF THE DRAWINGS

The invention's advantages described in this application will become more apparent when read with the exemplary embodiment described in the specification and shown in the drawings. Further, the accompanying drawings and descriptions that follow, like parts are indicated throughout the drawings and description with the same reference numerals, respectively. The figures may not be drawn to scale, and the proportions of certain parts have been exaggerated for the convenience of illustration.

FIG. 1 is a simplified system diagram of one embodiment of the major elements of a networked supply chain marketplace for the construction industry according to the current invention.

FIG. 2 is a simplified flowchart showing the major steps of the functioning of one embodiment of a networked supply chain marketplace for the construction industry, according to the current invention.

FIG. 3 illustrates the Entities selected to be on the team and were invited into the construction site's private network.

FIG. 4 is a screenshot of a Remote Mobile Computing Device (“RMCD”) of an embodiment of the current invention showing an interactive map with icons indicating the locations of jobsites, entities that need construction resources, and those that are offering construction resources.

FIG. 5 is a screenshot of an RMCD of an embodiment of the current invention allowing a user to search for specific construction resources within a defined radius.

FIG. 6 is a screenshot of an RMCD embodiment of the current invention showing the Entity's jobsites.

FIG. 7 is a screenshot of an RMCD of an embodiment of the current invention, a Post by an Entity offering “Lay Down Yards/Land for Lease”.

FIG. 8 is a screenshot of an RMCD of the current invention showing a tutorial indicating how to create a ‘Have’ Post.

FIG. 9 is a screenshot of an RMCD of the current invention showing a ‘Need’ Post for Mobile crushing and screening services.

FIG. 10 is a screenshot showing the bottom of the page of FIG. 9.

FIG. 11 is a screenshot of an RMCD of an embodiment of the current invention showing the “Calculators” page.

FIG. 12 is a screenshot of an RMCD of an embodiment of the current invention showing different shapes that may be chosen for calculating a volume of a shape.

### DETAILED DESCRIPTION OF THE INVENTION

The present invention will now be described in detail by describing various illustrative, non-limiting embodiments with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

The terminology used herein is to describe particular embodiments only and is not intended to be limiting of the invention. As used herein, the term “and/or” includes any and all combinations of one or more of the associated listed items. As used herein, singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for clarity, this description will refrain from repeating every possible combination of the individual steps in an unnecessary fashion. Nevertheless, the specification and claims should be read with the understanding that such combinations are entirely within the scope of the invention and the claims.

### 1. Theory

As indicated above, there are currently problems locating accurate supplies and materials for the construction industry. They rely on archaic and inaccurate means of communication, special calculations, data storage, and acquiring needed materials to complete a job. The current invention addresses and fixes these shortcomings.

### 2. Implementation

The current invention may be implemented in several different ways based on the end user's individual requirements.

A new and novel networked supply chain marketplace is discussed herein allowing for efficient materials and equipment exchange between construction entities. In the following description, for purposes of explanation, numerous specific details are set forth in order to provide a thorough understanding of the present invention. It will be evident, however, to one skilled in the art that the present invention may be practiced without these specific details.

The present disclosure is to be considered an exemplification of the invention and is not intended to limit the invention to the specific embodiments illustrated by the figures or description below.

### Operation of the System

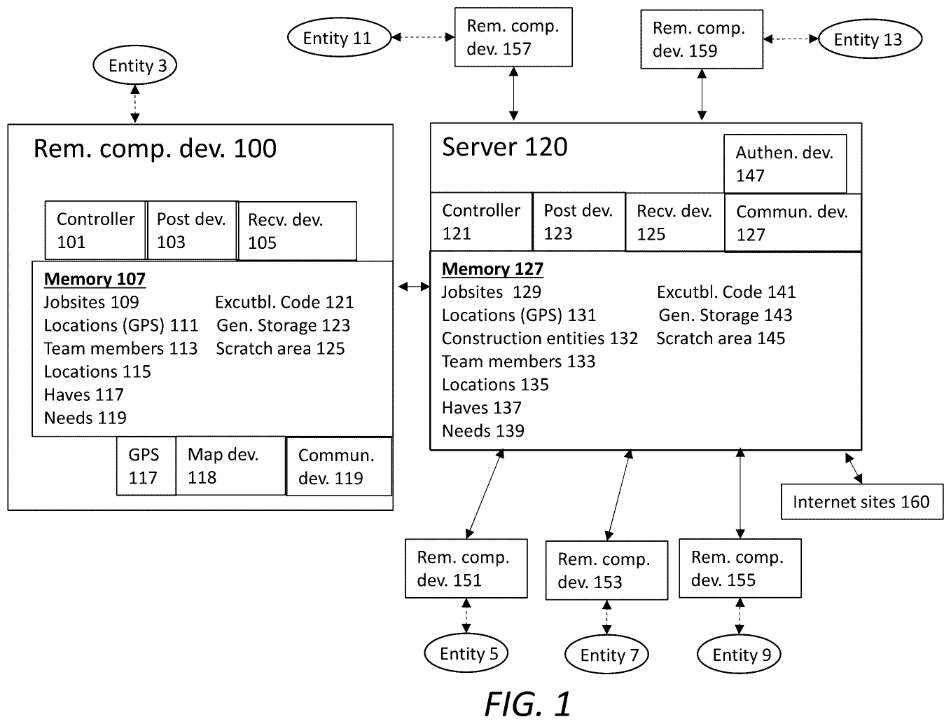

FIG. 1 shows a simplified system diagram of one embodiment of a networked supply chain marketplace for the Construction Industry according to the current invention.

A plurality of Remote Mobile Computing Devices (“RMCDs”) 100, 151-157 are each used by a plurality of construction Entities 3, 5, 7, 9, 11, 13. They joined this network to either acquire or provide construction materials or construction equipment. When acquiring, it can be purchasing materials/supplies, bartering for materials/supplies, purchasing equipment, renting equipment, or bartering for equipment. Providing can be selling, or bartering out materials/supplies, selling, bartering out, or renting out equipment. Construction materials and equipment may be collectively referred to as “construction resources”. (Only verified construction entities are allowed to join the network. This reduces the amount of irrelevant communication and spam on the network.)

Entities 3, 5, 7, 9, 11, and 13 may have materials, supplies, and equipment that they would like to sell, rent, or barter. Each construction resource that an Entity has is referred to as a ‘Have’. Entities may also require certain construction resources to complete a jobsite construction. Each of these needed resources is referred to as a ‘Need’.

Many entities will have both ‘Haves’ and ‘Needs’. Each ‘Have’ or ‘Need’ is treated independently on the current system.

Below is a table listing various construction resources. This Table is being provided to explain the construction resources that can be exchanged but is not an exhaustive list. Other related resources will be considered to be within the scope of and fall under the ‘spirit’ of this invention.

TABLE 1
CONSTRUCTION RESOURCES
MATERIALS, SUPPLIES, EQUIPMENT
I Have/I Need:

Clean Fill
Asphalt
Block
Concrete
Brick
Dirt
Gravel and Rock
Other
Equipment for Rent
Asphalt Equipment
Concrete Equipment
Excavation Equipment
Heavy Equipment
Snow Removal Equipment
Tree Service Equipment
Trucks
Other
Equipment for Sale
Asphalt Equipment
Concrete Equipment
Excavation Equipment
Heavy Equipment
Snow Removal Equipment
Tree Service Equipment
Trucks
Other
Organic Materials
Leaf & Lawn Debris
Stumps
Firewood logs
Woodchips
Other
Real Estate
Garage Space
Land For Sale
Lay Down Yards/Land For
Lease
Portable Office
Self Storage
Other

Some materials and supplies are needed, which are typically not provided by other contractors. These resources are shown in TABLE 2.

TABLE 2
ADDITIONAL CONSTRUCTION
RESOURCES
I Need/I Need:

Jobsite Safety
Signs and Barricades
Traffic Control
Trench Safety
Other
Jobsite Support Services
Cleaning Service
Drone Operations
Jobsite Security
Equipment Repair/Mobile Mechanic
Portable Toilets
Septic Service
Video Monitoring
Retail & Wholesale Supplies
Asphalt
Building Materials
Bulk Rock Salt
Fuel
Green House/Nursery
Hardware Store
Landscape Supplies
Masonry & Concrete
Plumbing Supplies
Other
Sanitation & Recycling
Roll Off Dumpsters
Scrap Yard
Other
Trucking & Transportation
Dump Truck
Flatbed
Hotshot
Lowboy
Roll Off Dumpsters
Towing
Water Truck
Other

TABLE 3 shows services that are needed for construction (‘Needs’) and those entities that are offering to supply these services (‘Haves’).

TABLE 3
CONSTRUCTION RESOURCES
SERVICES
I Have/I Need:

Concrete
Crane and Rigging Services
Dock Builder
Drilling & Blasting
Electrician
Environmental
Erosion Control
Finish Carpentry
Flooring Installer
General Contractor
Hardscaping
Heavy Highway
Home Builder
HydroVac Excavation
Insulation
Land Clearing
Land Developer
Landscaping
Logging
Mason
Mechanical
Mobile Crushing & Screening
Oil and Gas
Other
Paving
Painter
Plumbing
Pool installer
Remodeling
Roofing
Excavation & Site Work
Utility
Stone Mason
Solar Installation
Striping & Sealcoating
Welder

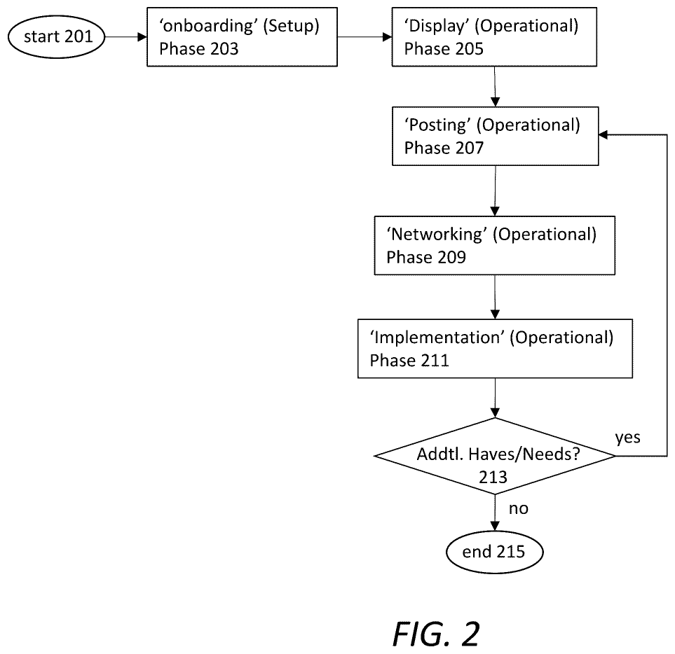

The functioning of the current system will be described below in the context of FIGS. 1 and 2. The process begins in FIG. 2 at the “start”, step 201.

### Onboarding

In step 203, the system enters the setup phase by performing an ‘onboarding’ function.

To join the current system, an Entity 3, using RMCD 100, contacts Server 120 through Communication device 119 through a network such as a cellular network and/or the Internet to Communication device 127 of Server 120.

RMCD 100 employs at least a Controller 101, Post device 103, Receiver device 105, GPS 117, Communication device 119 that may upload and run executable code 121, and other information stored in General storage 123 of Memory 107.

Server 120 employs at least a Controller 121, Post device 123, Receiver device 125, Communication device 127, and an Authentication device 147 that may upload and run executable code 141 and other information stored in General storage 143 of Memory 127.

### Authentication

Server 120 then performs authentication with Authentication device 147 to determine if Entity 3 is a construction Entity. (In an alternative embodiment, Authentication device 147 may also be an external Software as a Service (SaaS) authenticator.)

If Entity 3 is verified as a construction Entity, it is then requested to provide information about the user, the user's company, the type of Entity, its location, contact information, a description of what it has that it would like to sell, rent, or barter, descriptions of its ‘Needs’ that I would like to acquire.

This information is stored in Memory 127 of Server 120. (It may also be stored in Memory 107 of RMCD 100 for faster start-ups.)

The above process is performed for all initial entities which would like to be part of the system. After the requested information of all initial entities has been received and stored, the setup phase ends, and the Operational phase begins.

### Display

Step 205 is the first operational step.

In step 205, information of Jobsites 129, information acquired for construction entities 132 may be sent to RMCDs 100, and 151-159 to be displayed as icons on a map according to preselected filtering, representation at their respective locations, 131, 135 and 135 by a Map device 118 of RMCD 100.

Each RMCD screen should have buttons to change the entities being displayed interactively. For example, pressing the “Haves” button only displays entities on the map, indicating that they have construction resources to offer. Similarly, pressing the “Needs” button only displays entities on the map indicating that they need construction resources. The locations on the map should indicate the geographic locations of the entities. The distances from the jobsite may also be displayed.

Distance is one parameter considered when choosing which Entity to engage, as indicated in the “Background” above. Other parameters can be considered in choosing an Entity to engage. In an embodiment, entities can rate each other or provide “Likes’. Since Server 120 is involved with most of the system's actions, it can keep track of Posts, Invites, Likes, and Views. It also has information presented by the onboarding process. Server 120 also can acquire public information through connections to Internet sites 160.

Therefore, Server 120 can send various information to overlay on the map displayed to the Entities. For example, one embodiment may display the number of times an Entity is clicked to view its information. In another embodiment, it can be the number of ‘Likes’.

Since larger Entities may receive more views, on average as compared with small businesses, one can normalize the views or likes for the company size. (This information is provided by onboarding or can be found on various public internet sites.) The number of views divided by the company size would be a parameter that can be displayed on the map in another embodiment.

Since information gets ‘stale’, icons showing resources posted earlier are older. Icons for more recent Posts should be displayed as more prominent (brighter, larger, or have a higher number on them) than icons for resources posted earlier, in another embodiment of the invention.

Also, in still another embodiment, the amount of the material, supply, or equipment should have a relation to the icon displayed. Similarly, the value of the material, supply, or equipment should have a relation to the icon displayed. The icons may be made more prominent (brighter, larger, or have a higher number on them) for larger amounts of material.

In another embodiment, the number of Likes can be time-weighted. For example, a ‘Like’ two months ago has half of the value of a ‘Like’ today. This valuation gives more importance to more recent ‘Likes’.

The Entity may be able to choose how to display the icons on the map or may activate other screens having additional information on the entities. The prominence of the displayed icon may be a composite of several variables, such as:

$$= ( views ) / ( age of the Post )$$

$$= ( views ) / ( size of the Entity )$$

$$= ( Invites / ( age of the Invite )$$

$$= ( Invites / ( size of the Entity )$$

$$= ( resource value ) / ( age of the Post )$$

$$= ( resource value ) / ( size of the Entity )$$

$$= ( resource size ) / ( age of the Post )$$

$$= ( resource size ) / ( size of the Entity )$$

$$= ( Likes ) / ( age of the Post )$$

$$= ( Likes ) / ( size of the Entity )$$

$$= ( Likes ) / ( current month )$$

$$= ( Invites ) / ( current month )$$

Or similar composites.

### Posting

In step 207, entities are allowed to make Posts. The current system allows a broadcast system where each can′ Post′ the materials an Entity offers for sale, lease, or barter.

Post device 103 of RMCD 100 can interact with Entity 3 to select a construction resource that it requires (a ‘Need’ 119) stored in Memory 107 and send it through Communication device 119 and a network to Communication device 127 of Server 120.

Controller 101 recognizes this as a request for posting a ‘Need’ and broadcasts the Post to all entities. In an alternative embodiment of the system, Controller 101 only sends the Post to entities that match filter variables preset by the Posting Entity. In another embodiment, Controller 101 analyzes all of the ‘Haves’ 137 stored in Memory 127 of Server 120 relating to the resources of the attached entities. It notifies entities that may have resources that match the ‘Need’.

Similarly, Post device 103 of RMCD 100 can interact with Entity 3 to select a construction resource that it would like to offer (a ‘Have’ 117) stored in Memory 107 and send it through communication device 119 and a network to communication device 127 of Server 120.

Controller 101 recognizes this as a request for posting a ‘Have’ and broadcasts the Post to all entities. In an alternative embodiment of the system, Controller 101 only sends the Post to entities that match filter variables preset by the Posting Entity. In another embodiment, Controller 101 analyzes all of the ‘Needs’ 139 stored Memory 127 of Server 120 relating to the resources of the attached entities. It notifies those entities which may need resources that match the ‘Have’.

The current invention allows for any two entities to engage in private communication. Private communication allows the entities to negotiate the sale or barter of materials and services privately.

### Defining Jobsite

If an Entity having a resource enters into a deal with an Entity working on the jobsite, the entities are invited into a private network for the jobsite. Each jobsite can have its own private network.

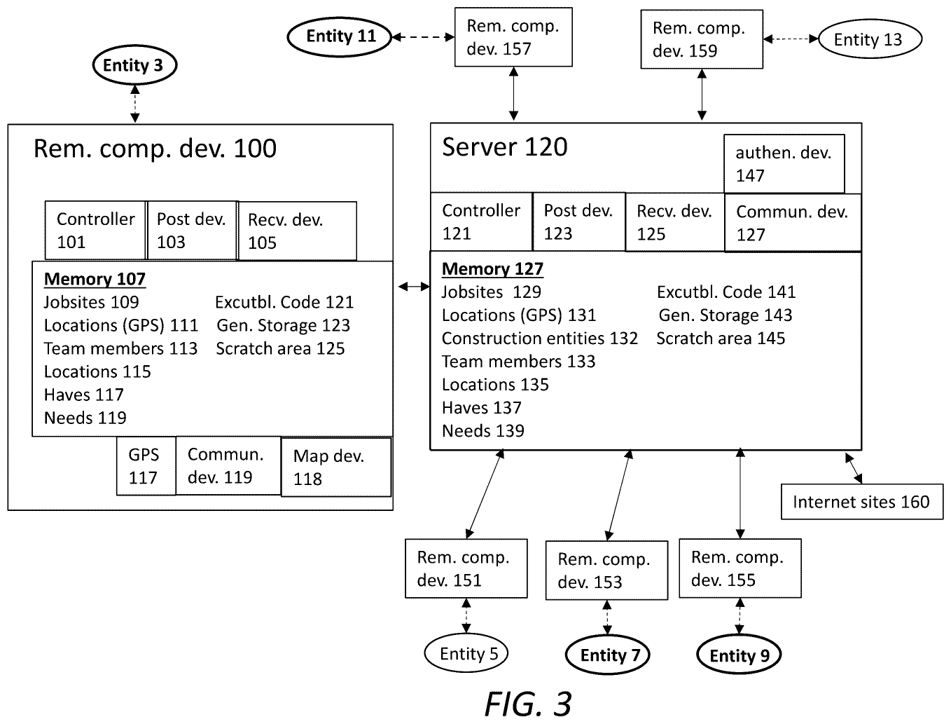

FIG. 3 illustrates the Entities selected to be on the team and were invited into the jobsite's private network.

In step 211, Entities 1, 7, 9, and 11 are invited as team members into the jobsite network. In one embodiment, information of team members 113, 133 is stored in Memory 107 of computing device 100 and Memory 127 of Server 120. This process results in a private networking group. Team members can communicate with all other team members in a broadcast mode or with specific team members of a specified type, category, etc. For example, a team member can message all paving contractors invited to work on the jobsite. This selective communication saves a tremendous amount of time for the contractor to explain the responsibilities of other subcontractors without providing unnecessary communications to other team members and minimizes confusion.

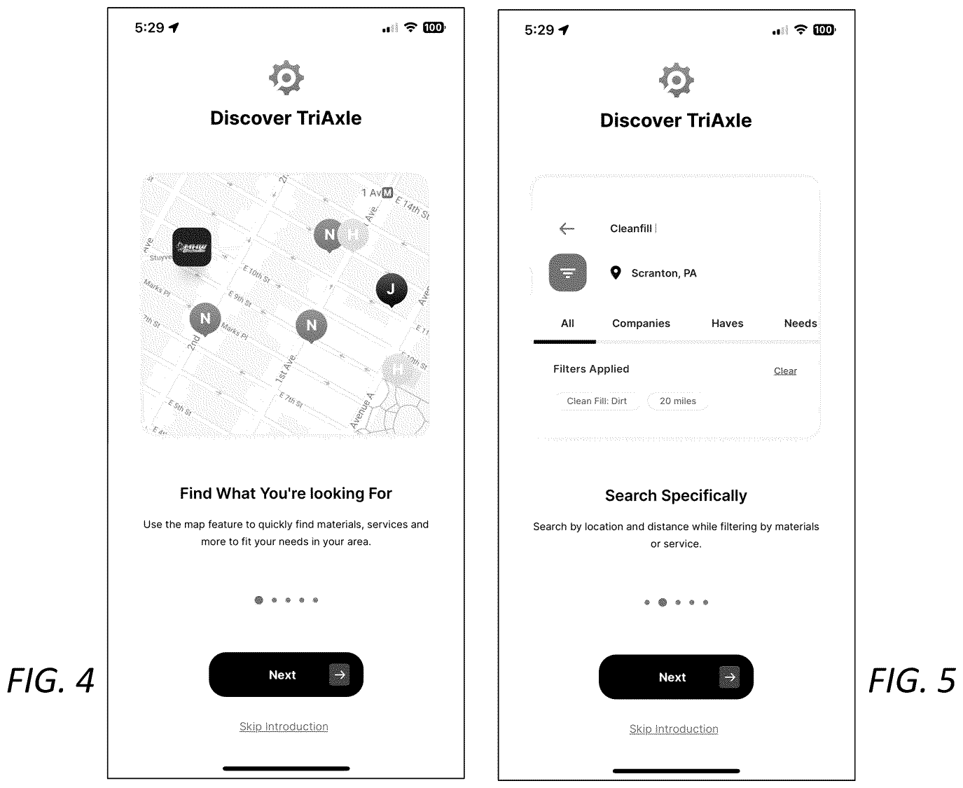

FIG. 4 shows a screenshot of an RMCD, such as a cellphone of the current invention showing an interactive map with icons “N” indicating the location of a construction resource that is needed, an “H” icon indicating the location of a construction resource that is being offered, and a “J” showing the location of a jobsite. The current invention uses a Global Positioning System (GPS) system and Geolocation Features allowing users to interact with a map to find materials, services, equipment, and other resources close to their local area.

The GPS triangulated map that displays all active jobsites, companies, and the requests that they need from other users. The map feature utilizes the phone's cellular, wireless, and GPS communications to accurately determine the exact location of each user regardless of the lack of a physical mailing address or other limitations common within the construction industry.

FIG. 5 is a screenshot of an RMCD of the current invention allowing a user to search for specific construction resources within a defined radius. In this case, the Entity searched for any entities offering “Clean Fill Dirt” within a 20-mile radius of “Scranton, PA”.

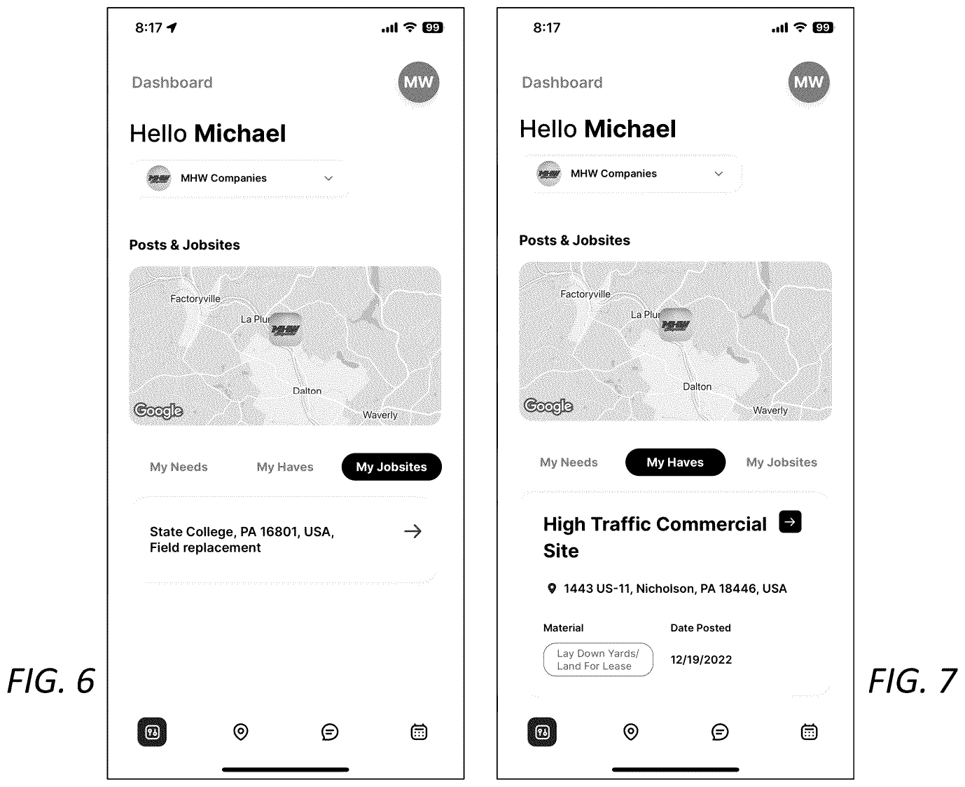

FIG. 6 shows a screenshot of an RMCD of the current invention with an interactive map showing the “Dashboard” display indicating a jobsite at “State College, PA 16801, USA. The display indicates that this is a “Field replacement”.

FIG. 7 is a screenshot of an RMCD of the current invention indicating where users post that it is offering “Lay Down Yards/Land for Lease” located at “1443 US-11, Nicholson, PA 18446 USA” to all on the current system. This ‘Have’ Post indicates that this is a “High Traffic Commercial Site”. This ‘Have’ Post was published on Dec. 19, 2022.

All communications within the invited private network, blueprints, photos, files, and data are secure since only invited users can collaborate.

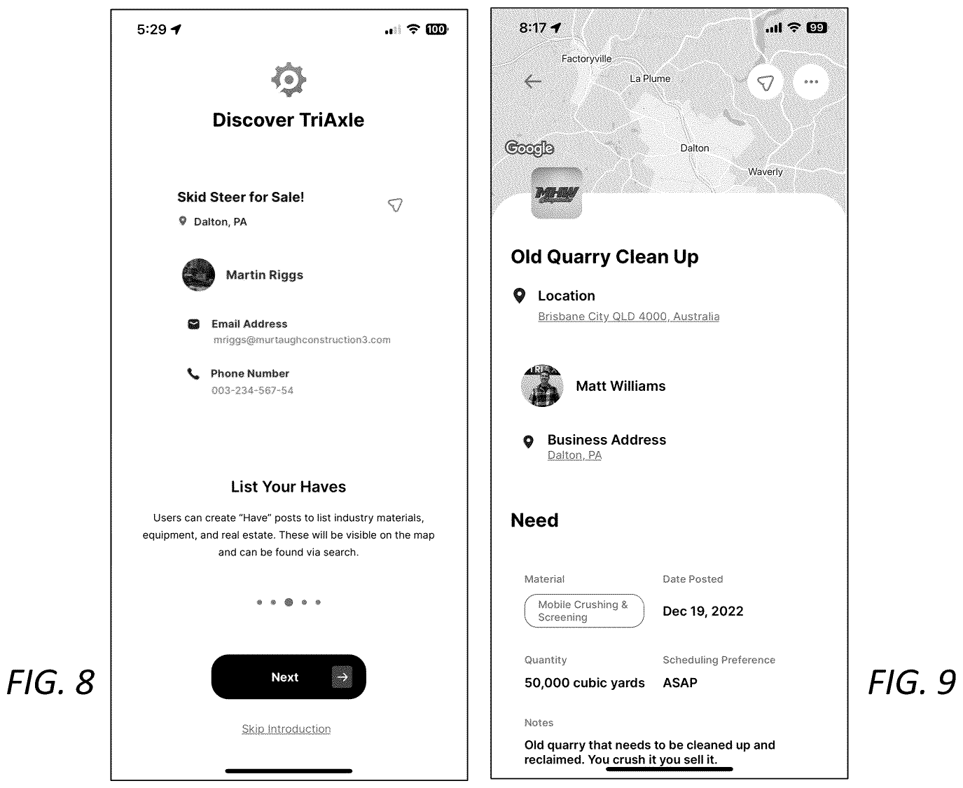

FIG. 8 is a screenshot of an RMCD of the current invention showing a tutorial indicating how to create a ‘Have’ Post. In this draft Post, Martin Riggs offers a Skid Steer for Sale. This Post will be published to all entities in the current system.

The ‘Have’ Post feature allows users to market the materials, services, manpower, equipment, etc., that they have and can provide to others immediately.

FIG. 9 is a screenshot of an RMCD of the current invention showing a ‘Need’ Post for a Contractor that does “Mobile Crushing & Screening” to clean up an Old Quarry Clean Up”. The Contractor is requested to start as soon as possible (ASAP). This job should result in 50,000 cubic yards of crushed stone that the Contractor crushes and sells. Matt Williams in Dalton, PA is responding to this Need Post.

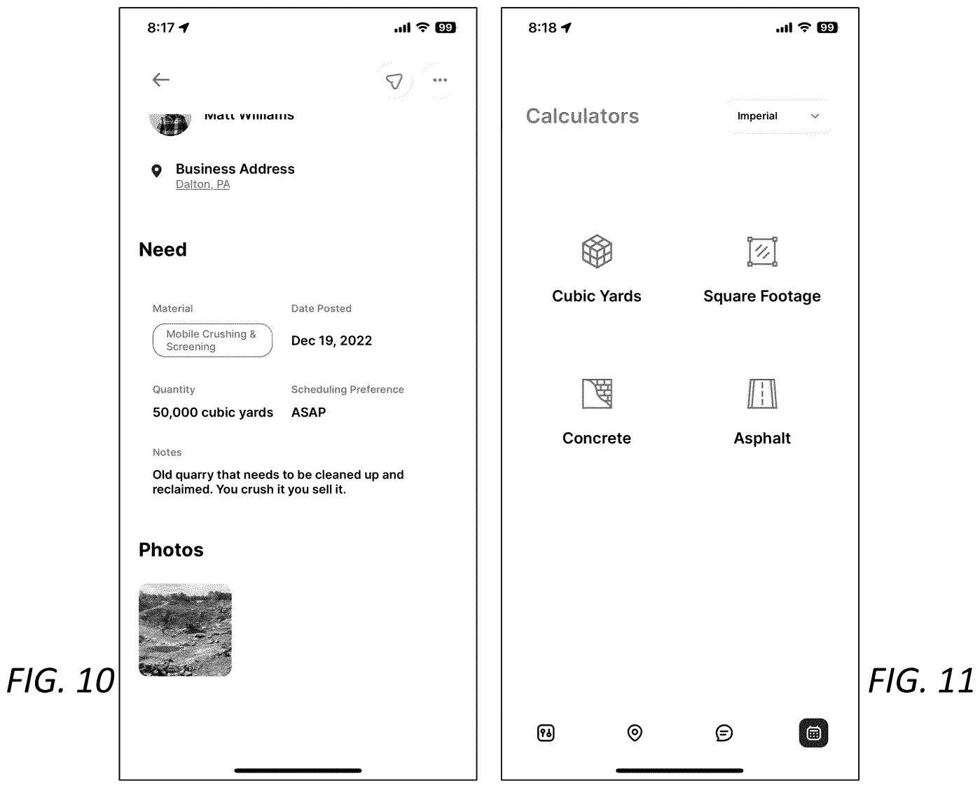

FIG. 10 is a screenshot showing the bottom of the page of FIG. 9.

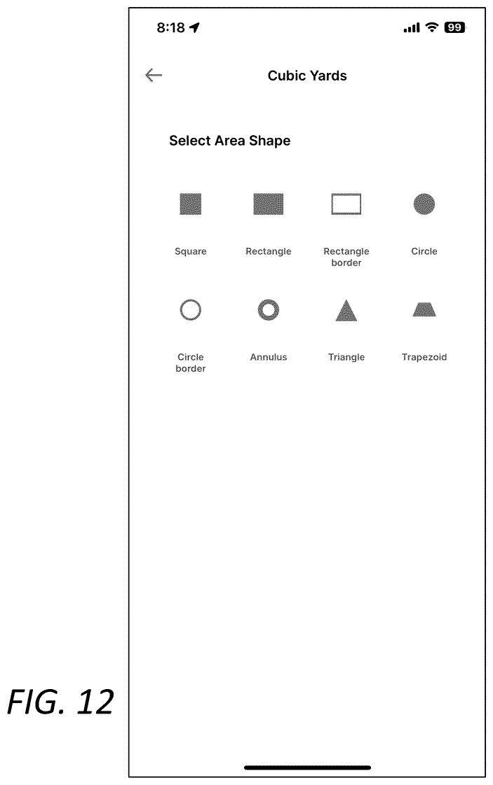

FIG. 11 is a screenshot of an RMCD of the current invention showing the “Calculators” page with buttons for calculating cubic yards, square footage, and amount of concrete and asphalt.

FIG. 12 is a screenshot of an RMCD of the current invention showing different shapes that may be chosen for calculating a volume of a shape.

These can calculate two-dimensional square footage, such as is required for determining an area to pave, or three-dimensional volumes based upon the shape of the volume to fill. For example, an Entity would select the “Cubic Yards” button on the screen shown in FIG. 11, then select the shape that best approximates the shape of the depression that needs to be filled. For example, if the depression has a substantially annular shape, “Annulus” is selected as the Area Shape in FIG. 12. The system then prompts the Entity to enter the approximate radius of the inner radius and then the outer radius as well as an approximate depth. It will then calculate the approximate fill required in the units that fill is typically sold (cubic yards).

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the preceding aspects are illustrative, and no single feature or element essential to all possible combinations may be claimed in this or a later application.

We claim:

1. A networked supply chain marketplace comprising:
a. a Providing Remote Computing Device (RCD) associated with a construction entity that communicates that a Providing Entity has excess construction resources available at a location that it would like to provide to another construction entity;
b. a plurality of Requesting RCDs each associated with a Requesting Construction Entity requiring construction resources, each coupled to the Providing RCD capable of receiving the communication from the Providing RCD defining the excess construction resources, the amount and their location;
c. wherein the Requesting RCDs are capable of asking questions to, receiving answers from, negotiating with and accepting the excess construction resource from the Providing RCD;
d. wherein, after one of the Requesting RCDs accepts the excess construction resources, the Providing RCD indicates that the excess construction resources are no longer available.

2. The networked supply chain marketplace of claim 1, wherein any of the RCDs may both post and receive communications.

3. The networked supply chain marketplace of claim 1, wherein the construction resources are at least one of construction materials, construction supplies, and construction equipment.

4. The networked supply chain marketplace of claim 1, wherein all entities/RCDs are coupled through a server that keeps track of excess resources and their locations for each entity, and entities needing resources and the locations where they are needed.

5. The networked supply chain marketplace of claim 4, wherein the server keeps track of construction site locations, the excess construction resources at each construction site, and entities needing construction resources.

6. The networked supply chain marketplace of claim 4, wherein the server displays excess construction resources requested by an RCD and estimates and displays delivery costs to a delivery location defined by the requesting RCD/entity.

7. The networked supply chain marketplace of claim 6, wherein the delivery costs are determined by identifying a route from the excess materials location to the desired delivery location.

8. The networked supply chain marketplace of claim 7, wherein the identified route allows trucks large enough to carry the excess construction materials.

9. A networked supply chain marketplace system for the construction industry comprising:
a. a plurality of Mobile Computing Devices (“MCDs”), each associated with a construction Entity, whereas one of the Entities is a General Contractor (GC) in charge of completing construction on a jobsite;
b. wherein the MCD receives and transmits the GC's determination of which Entities will be on a team working on the jobsite;
c. wherein each MCD is capable of displaying an interactive map showing the locations of jobsites and other construction entities that are offering construction resources, and construction entities that are requesting construction resources;
d. wherein each MCD has an internal Memory capable of storing information of its associated Entity's jobsites, excess construction resources that it has for the jobsite, and the construction resources it needs to complete work on a jobsite;
e. wherein each MCD also is capable of interacting with its associated Entity to create and send posts offering excess construction resources that it has that it would like to offer to other Entities;
f. wherein each MCD also is capable of interacting with its associated Entity to create and send posts requesting construction resources that it needs from other Entities;
g. a Server coupled to the plurality of MCDs, is adapted to:
i. receive indications from the MCD associated with the GC on which Entities are authorized to work on the jobsite, and will be part of the private network;
ii. set up connections to allow team members to freely communicate with each other in the private network;
iii. receive posts from the MCDs and determine which other MCDs should receive the posts, and provide the Posts to those remote Entities that should receive them; and
iv. connect MCDs to allow them to communicate with each other, upon request.

10. The networked supply chain marketplace system of claim 1, wherein:
a. the Server can monitor how many times an Entity was contacted about a contraction resource listed in a Post; and
b. displays this information near the icon associated with the construction resource contacted.

11. The networked supply chain marketplace system of claim 1, wherein the Server:
a. is adapted to monitor how many times an Entity was invited to work on a jobsite; and
b. displays this information near the icon associated with the Entity that was invited.

12. The networked supply chain marketplace for the construction industry of claim 3, wherein the Server:
displays a quantity equal to invitations per view being the number of times that an Entity was invited work on a jobsite divided by the number of times that the Entity was viewed.

13. The networked supply chain marketplace system of claim 1, further comprising:
at least one communication device connected to the Server that communicates with at least one Internet site, wherein the Server to collect corporate information from the Internet site of a size of each Entity and uses the Entity sizes to normalize analytic information posted for the Entity.

14. A networked construction resource marketplace comprising:
a. a first plurality of remote computing device (RCD) each associated with a Requesting Entity requiring construction resources, the RCD capable of posting a description of the construction resources needed with a location where the construction resource is needed;
b. a second plurality of remote computing device (RCD) each associated with a Providing Entity having excess construction resources that it intends to provide with a location of where the excess construction resource is located;
c. a server coupled to and communicating with the RCDs of the Requesting Entities and the RCDs of the Providing Entities;
d. the Server capable of providing visual representations of locations and descriptions of the excess construction materials, and locations and descriptions of the construction materials needed;
e. the Server capable of calculating routes and cost of delivery between various locations of excess construction materials and locations where these materials are required;
f. the Server capable of connecting RCDs of Requesting Entities with RCDs of Providing Entities to communicate;
g. Providing Entities and Requesting Entities with descriptions of the construction resources;
h. wherein the Server is also capable of coupling RCDs to allow Requesting Entities to communicate with Providing Entities and complete deals;
i. wherein the Server is also capable of calculating routes between specific locations of the excess construction resource and location where the resource is required, and calculating the costs for delivery; and
j. the Server is capable of tracking the locations of the excess construction materials and providing visual representations of progress of delivery of the excess construction materials.

15. The networked construction resource marketplace of claim 14, wherein:
the Server is capable of tracking the locations of the RCDs of Providing Entities carrying the excess construction materials to provide visual representations of progress of delivery of the excess construction materials.

16. The networked construction resource marketplace of claim 14, wherein:
the Server has the ability to adjust the information displayed connected RCDs to selectively display locations of Requesting RCDs, Providing RCDs, limit the displays to a defined radius, display only locations of specified construction resources, and display delivery costs.

17. The networked construction resource marketplace of claim 14, wherein:
construction resources includes construction materials, construction supplies, and construction equipment.

18. The networked construction resource marketplace of claim 14, wherein:
the Providing Entity indicated to the Server the amount of excess construction resources to be provided, the Requesting Entity indicates to the Server how much construction resources are required and the Server displays this information on the RCDs associated with both Entities.

19. The networked construction resource marketplace of claim 14, wherein:
the Requesting Entities and Providing Entities may both request construction resources and post that it has other excess construction resources to provide.

20. The networked construction resource marketplace of claim 14, wherein:
the Server is further capable of estimating volumes required to fill geometric shapes based upon an Entity's input through the MCD of shape and size dimensions.
